(19) United States
(12) Patent Application Publication
(10) Pub. No.: US 2017/0374058 A1
(43) Pub. Date: Dec. 28, 2017

(54) AUTHENTICATION SYSTEM, COMMUNICATION SYSTEM, AND AUTHENTICATION AND AUTHORIZATION METHOD

(71) Applicants: Takeshi HORIUCHI, Tokyo (JP); Naoki UMEHARA, Kanagawa (JP); Hiroshi HINOHARA, Kanagawa (JP); Atsushi MIYAMOTO, Kanagawa (JP); Takuya SONEDA, Kanagawa (JP)

(72) Inventors: Takeshi HORIUCHI, Tokyo (JP); Naoki UMEHARA, Kanagawa (JP); Hiroshi HINOHARA, Kanagawa (JP); Atsushi MIYAMOTO, Kanagawa (JP); Takuya SONEDA, Kanagawa (JP)

(21) Appl. No.: 15/621,108

(22) Filed: Jun. 13, 2017

(30) Foreign Application Priority Data
Jun. 23, 2016 (JP) 2016-124755

(51) Int. Cl. H04L 29/06; H04W 12/06; H04L 9/32

(52) U.S. Cl. CPC H04L 63/0823; H04L 9/3263; H04W 12/06

(57) ABSTRACT

An authentication system, a communication system, and a method of performing authentication and authorization. The authentication system and the method include establishing a first connection with a communication terminal after performing authentication with client certificate sent from the communication terminal, outputting authorization data corresponding to the client certificate, the authorization data indicating authorization for the communication terminal to access a resource, and controlling the communication terminal to transmit the authorization data to a resource provision system through a second connection different from the first connection. The communication system includes the authentication system, and a resource provision system that checks the authorization data and provides the communication terminal with the resource.

### CROSS-REFERENCE TO RELATED APPLICATION

This patent application is based on and claims priority pursuant to 35 U.S.C. §119(a) to Japanese Patent Application No. 2016-124755, filed on Jun. 23, 2016, in the Japan Patent Office, the entire disclosure of which is hereby incorporated by reference herein.

### BACKGROUND

### Technical Field

Embodiments of the present disclosure relate to an authentication system, a communication system, and an authentication and authorization method.

### Background Art

For example, protocols such as transport layer security (TLS) is known in the art where a connection with a communication terminal is established after authenticating a client using client certificate. Moreover, protocols such as OAuth 2.0 is known in the art where a request sender can access resources after the communication terminal that has sent the request for resources is authenticated and authorized.

JP-2014-531163-A relates to a method including a step of transmitting identifier, authentication credential, and access permission to a centralized secure management system in a distinguishable format, using a third-party application, a step of transferring the identifier and the access permission to a permission server using the centralized secure management system after the third-party application is successfully authenticated, and a step of issuing an access token to the third-party application via the centralized secure management system when the access permission is valid, where the access token is used to access resources to which access by users is controlled by the permission server.

### SUMMARY

Embodiments of the present disclosure described herein provide an authentication system, a communication system, and a method of performing authentication and authorization. The authentication system and the method include establishing a first connection with a communication terminal after performing authentication with client certificate sent from the communication terminal, outputting authorization data corresponding to the client certificate, the authorization data indicating authorization for the communication terminal to access a resource, and controlling the communication terminal to transmit the authorization data to a resource provision system through a second connection different from the first connection. The communication system includes the authentication system, and a resource provision system that checks the authorization data and provides the communication terminal with the resource.

### BRIEF DESCRIPTION OF THE DRAWINGS

A more complete appreciation of exemplary embodiments and the many attendant advantages thereof will be readily obtained as the same becomes better understood by reference to the following detailed description when considered in connection with the accompanying drawings.

FIG. 1 is a schematic diagram illustrating a configuration of a communication system according to an embodiment of the present disclosure.

FIG. 2 is a schematic block diagram illustrating a hardware configuration of a communication terminal according to an embodiment of the present disclosure.

FIG. 3 is a schematic block diagram illustrating a hardware configuration of a management system according to an embodiment of the present disclosure.

FIG. 4 is a functional block diagram of a communication terminal and a management system, according to an embodiment of the present disclosure.

FIG. 5 is a sequence diagram illustrating processes according to an embodiment of the present disclosure.

The accompanying drawings are intended to depict exemplary embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that have the same structure, operate in a similar manner, and achieve a similar result.

In the following description, an embodiment of the present invention is described with reference to the drawings.

<<Schematic Configuration of Communication System>>

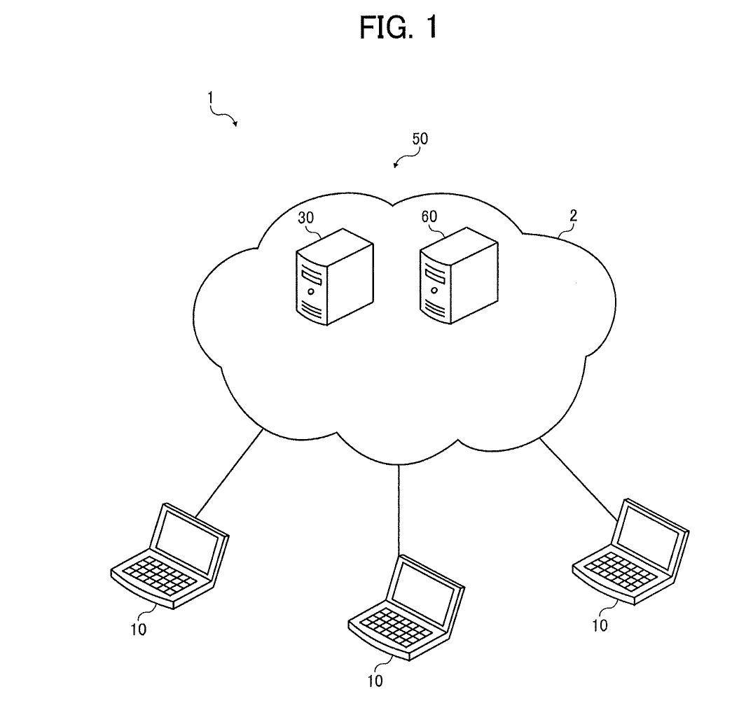

FIG. 1 is a schematic diagram illustrating a configuration of a communication system according to the present embodiment.

In FIG. 1, a communication network 2 includes the service side related to authentication and resource provision, and the user side is connected to the communication network 2.

Hereinafter, any one of communication terminals 10 may be referred to as a communication terminal 10. The communication system 1 includes the communication terminals 10 and the management system 50. The management system 50 includes an authentication system 30 and a resource provision system 60. The communication terminal 10 may be, for example, a general-purpose terminal such as a tablet personal computer (PC), a smartphone, and a PC, or a personal communication terminal such as a television conference terminal, an electronic whiteboard, digital signage, and a camera. In the communication system 1, the number and type of the communication terminal is not limited. The types of the communication terminals 10 may be similar to each other, or may be different from each other.

In the communication system 1, the resources are stored, for example, in the management system 50 or in any desired server in the communication network 2. The resources are, for example, data such as an address book or session history, or a talking application or a video conference application.

The authentication system 30 authenticates the request sender terminal using the client certificate sent from the communication terminal 10 that has sent the request for authentication, and establishes a transport layer security (TLS) connection with the communication terminal 10. The resource provision system 60 allows the communication terminal 10 that is the request sender of the resources to access the resources.

<<Hardware Configuration>>

Next, the hardware configuration of the elements of the communication system 1 is described.

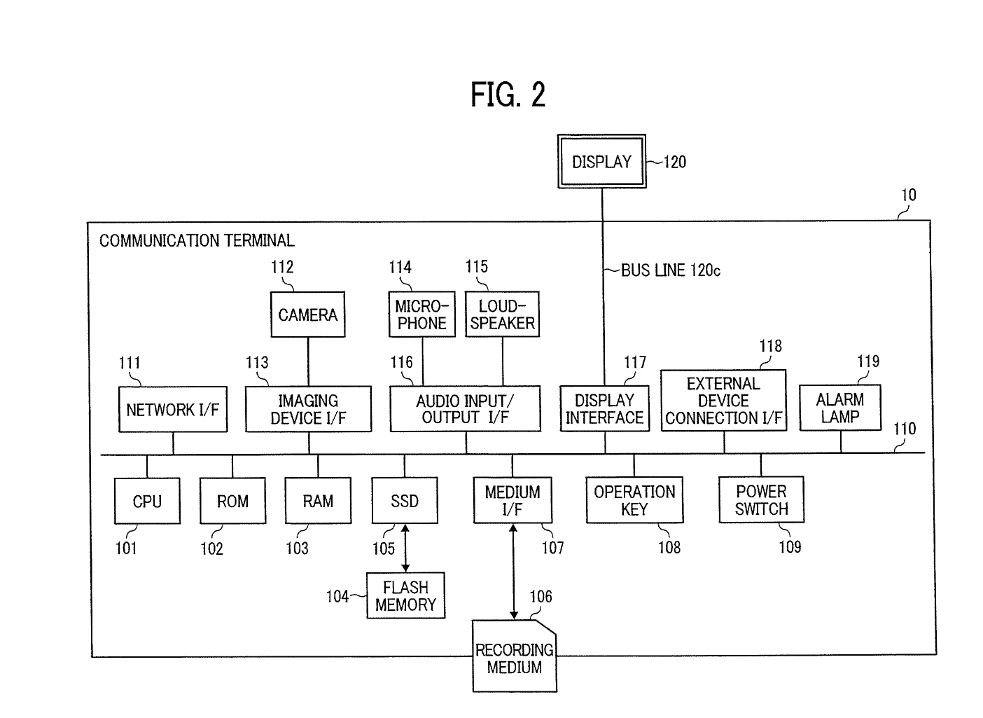

FIG. 2 is a schematic block diagram illustrating the hardware configuration of the communication terminal 10 according to the present embodiment.

The hardware configuration of the communication terminal 10 is not limited to the hardware configuration illustrated in FIG. 2 as long as the communication terminal 10 is capable of performing communication. For example, the communication terminal 10 may include an additional element that is not illustrated in FIG. 2. Alternatively, some of the elements illustrated in FIG. 2 may be omitted. Moreover, some of the elements illustrated in FIG. 2 may be, for example, an external device that can be coupled to the communication terminal 10.

As illustrated in FIG. 2, the communication terminal 10 of the embodiment includes a central processing unit (CPU) 101 that controls entire operation of the communication terminal 10, a read only memory (ROM) 102 that stores a program for operating the CPU 101 such as an initial program loader (IPL), a random access memory (RAM) 103 that operates as a work area for the CPU 101, a flash memory 104 that stores various types of data, such as the terminal control program, image data, and sound data, a solid state drive (SSD) 105 that controls reading/writing of various types of data from/to the flash memory 104 under control of the CPU 101, a medium I/F 107 that controls reading/writing (storage) of data from/to a recording medium 106 such as a flash memory or integrated circuit (IC) card, the operation key 108 operated in the case of, for example, selecting a counterpart terminal of the communication terminal 10, the power switch 109 for turning on/off the power of the communication terminal 10, and a network interface (I/F) 111 for transmitting data using the communication network 2.

The communication terminal 10 further includes the built-in camera 112 that captures an image of a subject and obtains image data under control of the CPU 101, an imaging element I/F 113 that controls driving of the camera 112, the built-in microphone 114 that receives an audio input, the built-in loudspeaker 115 that outputs sounds, an audio input and output (input/output) interface (I/F) 116 that processes inputting/outputting of an audio signal between the microphone 114 and the loudspeaker 115 under control of the CPU 101, a display interface (I/F) 117 that transmits image data to an external display 120 under control of the CPU 101, an external device connection interface (I/F) 118 for connecting various external devices, an alarm lamp 119 for notifying of an error in functionality of the communication terminal 10, and a bus line 110 such as an address bus and a data bus for electrically connecting the above-described elements as illustrated in FIG. 2.

The display 120 is a display made of liquid crystal or organic electroluminescence (EL) that displays an image of a subject, an operation icon, or the like. The display 120 is connected to the display interface 117 via a cable 120c. The cable 120c may be an analog red green blue (RGB) (video graphic array (VGA)) signal cable, a component video cable, a high-definition multimedia interface (HDMI, registered trademark) signal cable, or a digital video interactive (DVI) signal cable.

The camera 112 includes a lens and a solid-state image sensing device that converts an image (video) of a subject to electronic data through photoelectric conversion. As the solid-state imaging element, for example, a complementary metal-oxide-semiconductor (CMOS) or a charge-coupled device (CCD) is used.

To the external device connection interface 118, an external device such as an external camera, an external microphone, and an external loudspeaker can be electrically connected, through a Universal Serial Bus (USB) cable or the like that is inserted into a connection port 1132 of the housing of a housing 1100. In cases where an external camera is connected, the external camera is driven on a priority basis and the built-in camera 112 is not driven under the control of the CPU 101. In a similar manner to the above, in the case where an external microphone is connected or an external loudspeaker is connected, the external microphone or the external loudspeaker is driven under the control of the CPU 101 on a top-priority basis over the built-in microphone 114 or the built-in loudspeaker 115.

The recording medium 106 is removable from the communication terminal 10. In addition, a nonvolatile memory that reads or writes data under the control of the CPU 101 is not limited to the flash memory 104, and for example, an electrically erasable and programmable read-only memory (EEPROM) may be used instead.

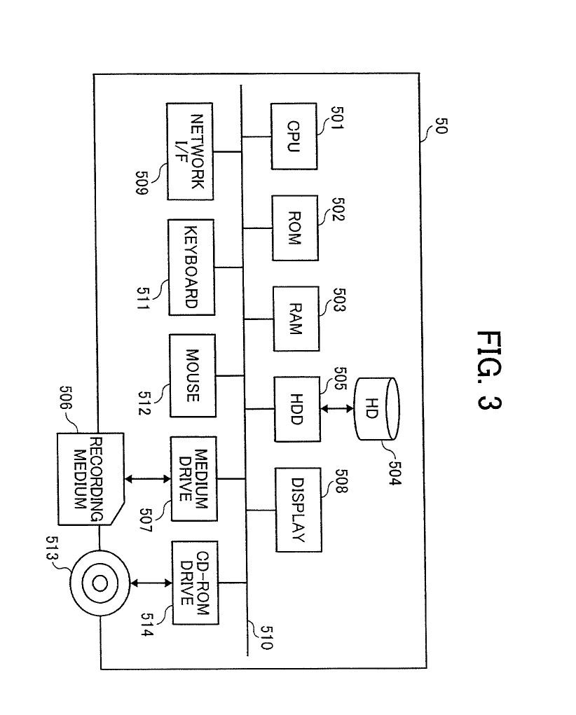

FIG. 3 is a schematic block diagram illustrating a hardware configuration of the management system 50 according to the present embodiment.

The management system 50 according to the present embodiment includes a CPU 501 that controls the entire operation of the management system 50, a ROM 502 that stores a control program for controlling the CPU 501 such as the IPL, a RAM 503 that is used as a work area for the CPU 501, a hard disk (HD) 504 that stores various kinds of data such as a control program for the management system 50, a hard disk drive (HDD) 505 that controls reading or writing of various kinds of data to or from the HD 504 under control of the CPU 501, a medium drive 507 that controls reading or writing of data from and to a recording medium 506 such as a flash memory, a display 508 that displays various kinds of information such as a cursor, a menu, a window, a character, and an image, a network interface (I/F) 509 that performs data communication using the communication network 2, a keyboard 511 that is provided with a plurality of keys for allowing a user to input, for example, characters, numerical values, and various kinds of instructions, a mouse 512 for, for example, selecting or executing various kinds of instructions, selecting an object to be processed, and for moving a cursor, a compact disc read only memory (CD-ROM) drive 514 that reads or writes various kinds of data from and to a CD-ROM 513, which is one example of removable recording medium, and a bus line 510 such as an address bus or a data bus that electrically connects various elements as above to each other as illustrated in FIG. 3.

Note that each one of the authentication system 30 and the resource provision system 60, which together configure the management system 50, has the configuration as illustrated in FIG. 3.

<<Functional Configuration>>

Next, the functional configuration according to the present embodiment is described.

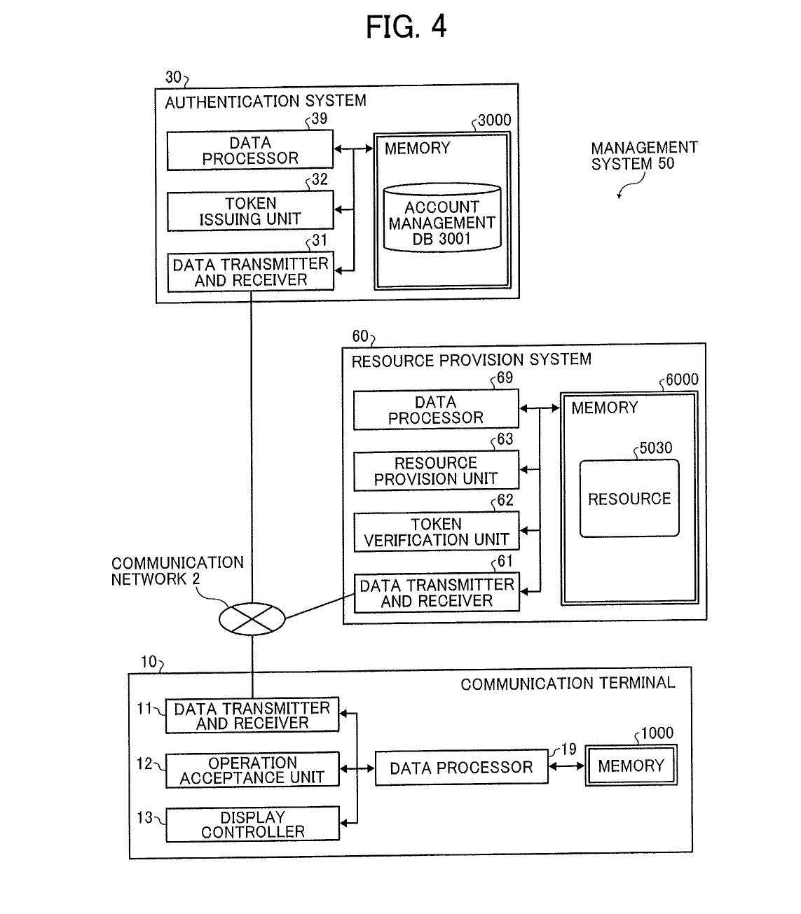

FIG. 4 is a schematic block diagram illustrating a functional configuration of the communication terminal 10 and the management system 50 in the communication system 1, according to the present embodiment.

In FIG. 4, the communication terminal 10 and the management system 50 are connected with each other so as to perform data communication through the communication network 2.

<Functional Configuration of Communication Terminal>

The communication terminal 10 includes a data transmitter and receiver 11, an operation acceptance unit 12, a display controller 13, and a data processor 19. These elements are functions that are implemented by the operation of some of the hardware components illustrated in FIG. 2 executed by the instructions from the CPU 101 in accordance with a control program expanded from the flash memory 104 onto the RAM 103. The communication terminal 10 further includes a memory 1000 configured by the ROM 102, the RAM 103, and the flash memory 104 illustrated in FIG. 2.

<Detailed Functional Configuration of Communication Terminal>

Next, the functional configuration of the communication terminal 10 is described in detail with reference to FIG. 2 and FIG. 4. In the following description of the functional configuration of the communication terminal 10, the relation of the hardware elements in FIG. 2 with the functional configuration of the communication terminal 10 will also be described.

The data transmitter and receiver 11 is implemented by the network interface 111 and the instructions from the CPU 101 illustrated in FIG. 2, and transmits or receives various kinds of data (or information) to or from, for example, a counterpart communication terminal, devices and apparatuses, or a system, through the communication network 2.

The operation acceptance unit 12 are implemented by the instructions from the CPU 101, the operation key 108, or the power switch 109, and receives various kinds of inputs from the user or receives various kinds of selection made by the user.

The display controller 13 is substantially implemented by the instructions from the CPU 101 illustrated in FIG. 2 and the display interface 117 illustrated in FIG. 2, and sends the image data that is sent from the counterpart communication terminal to the display 120 during the conversation.

The data processor 19 is substantially implemented by the instructions from the CPU 101 and the SSD 105 each of which is illustrated in FIG. 2. Alternatively, the data processor 19 is substantially implemented by the instructions from the CPU 101 illustrated in FIG. 2, and performs processing to store various types of data in the memory 1000 or read various types of data stored in the memory 1000.

<Functional Configuration of Management System>

The authentication system 30 of the management system 50 includes a data transmitter and receiver 31, a token issuing unit 32, and a data processor 39. These elements are functions implemented by or caused to function by operating some of the elements illustrated in FIG. 3 under the control of the instructions from the CPU 501. Note also that such instructions from the CPU 501 are made in accordance with a program for the authentication system 30 expanded from the HD 504 to the RAM 503. The authentication system 30 also includes a memory 3000 that is configured by the HD 504 illustrated in FIG. 3.

<Account Management Table>

Table 1 is a diagram illustrating an example data structure of an account management table, according to the present embodiment. In the memory 3000, as illustrated in FIG. 4, an account management database (DB) 3001 that is made of an account management table is stored. The account management table stores the common name and the resource ID of the resources to which an account is authorized to access, in association with each other, on account ID (identifier, identification) by account ID basis. With the account ID, an account that is authorized to access specific resources can be identified. The common name is included in the client certificate that is used when the TLS connection is established, and the counterpart communication terminal of the TLS connection, i.e., the communication terminal 10 side, can be identified by the common name. In the present embodiment, ID and names may be indicated by any desired data such as a text, number, and a sign. The ID may be a mail address or a telephone number that could uniquely identify the user.

TABLE 1

| Account ID | Common Name | Resource ID |
|---|---|---|
| A101 | CN101 | R1001, R1002 |
| A102 | CN102 | R2001, R2002, R2003 |
| — | — | — |

The data transmitter and receiver 31 is implemented by the network interface 509 and the instructions from the CPU 501 illustrated in FIG. 3, and transmits or receives various kinds of data (or information) to or from the other communication terminals, apparatuses, or systems through the communication network 2.

The token issuing unit 32 is implemented by the instructions from the CPU 501 illustrated in FIG. 3, and issues an access token in response to a request sent from the communication terminal 10.

The data processor 39 is substantially implemented by the instructions from the CPU 501 and the HDD 505 each of which is illustrated in FIG. 3 performs processing to store various types of data in the memory 3000 or read various types of data stored in the memory 3000.

The resource provision system 60 of the management system 50 includes a data transmitter and receiver 61, a token verification unit 62, a resource provision unit 63, and a data processor 69. These elements are functions implemented by or caused to function by operating some of the elements illustrated in FIG. 3 under the control of the instructions from the CPU 501. Note also that such instructions from the CPU 501 are made in accordance with a program for the resource provision system 60 expanded from the HD 504 to the RAM 503. The resource provision system 60 also includes a memory 6000 that is configured by the HD 504 illustrated in FIG. 3.

In the memory 6000, the resource 5030 is stored in association with the resource ID. When the access token obtained from the communication terminal 10 is verified to be authentic, the resource provision unit 63 provides the communication terminal 10 with the resource 5030.

The data transmitter and receiver 61 is implemented by the network interface 509 and the instructions from the CPU 501 illustrated in FIG. 3, and transmits or receives various kinds of data (or information) to or from the other communication terminals, apparatuses, or systems through the communication network 2.

The token verification unit 62 is implemented by the instructions from the CPU 501 illustrated in FIG. 3, and checks the access token sent from the communication terminal 10.

The resource provision unit 63 is implemented by the instructions from the CPU 501 illustrated in FIG. 3, and provides the communication terminal 10 with the resources according to the result of the check made to the access token.

The data processor 69 is substantially implemented by the instructions from the CPU 501 and the HDD 505 each of which is illustrated in FIG. 3 performs processing to store various types of data in the memory 6000 or read various types of data stored in the memory 6000.

<Operation>

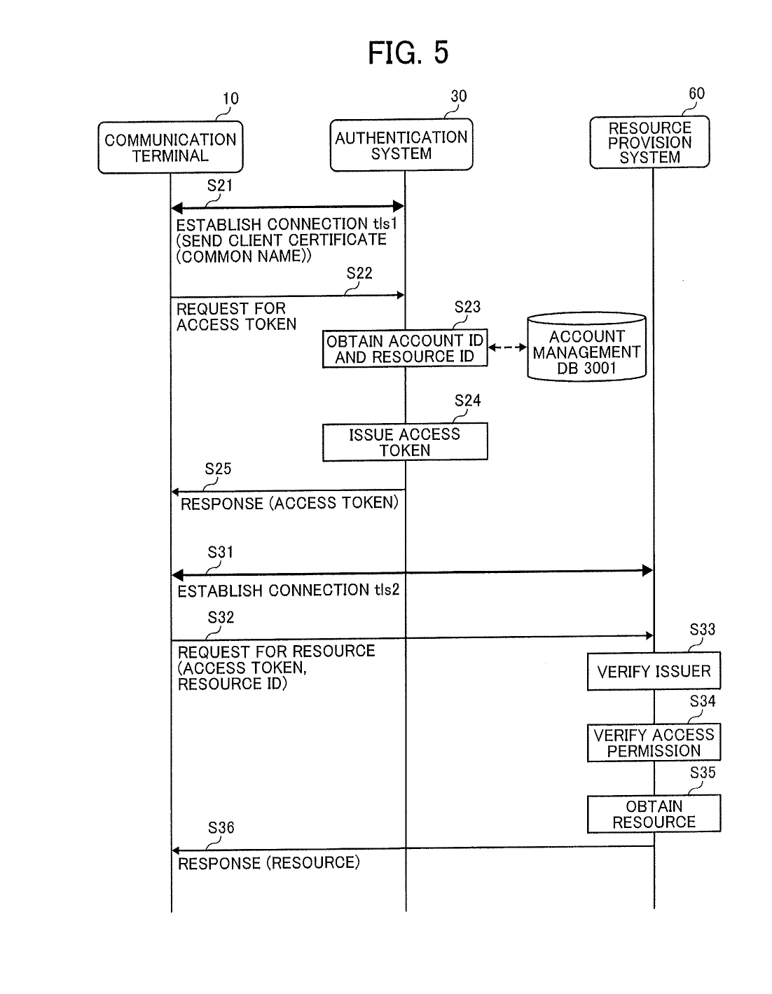

Next, operation of the communication terminal 10 and the management system 50 that together configure the communication system 1 is described. Firstly, the authentication processes according to the present embodiment are described with reference to FIG. 5.

FIG. 5 is a sequence diagram illustrating the authentication processes according to the present embodiment.

The data transmitter and receiver 11 of the communication terminal 10 and the data transmitter and receiver 31 of the authentication system 30 have the basic functions of the TLS communication. The data transmitter and receiver 11 of the communication terminal 10 and the data transmitter and receiver 31 of the authentication system 30 establishes a connection tls1 using the handshaking protocol of the TLS (step S21). According to the handshaking protocol, the data transmitter and receiver 11 of the communication terminal 10 sends an encrypted client certificate to the authentication system 30. The client certificate may be stored in the memory 1000 of the communication terminal 10, the flash memory 104, or the recording medium 106, or may be obtained from external device through the external device connection interface 118. The client certificate includes a common name that identifies the communication terminal 10 side. The data transmitter and receiver 31 of the authentication system 30 receives the encrypted client certificate, and decrypts the received encrypted client certificate. By so doing, the data transmitter and receiver 31 of the authentication system 30 authenticates the communication terminal 10 side that serves as a client.

Once the connection tls1 is established, the data transmitter and receiver 11 of the communication terminal 10 and the data transmitter and receiver 31 of the authentication system 30 starts the data communication using the data that is encrypted by the common key of the connection tls1. In this communication, the data transmitter and receiver 11 of the communication terminal 10 sends a request for an access token to access the resource 1030 to the authentication system 30 (step S22). The data transmitter and receiver 31 of the authentication system 30 that has received the request for the access token adds the common name included in the client certificate received in the step S21 to the request for the access token, and transfers the resultant data to the token issuing unit 32.

The token issuing unit 32 of the authentication system 30 uses the common name added to the request for the access token as a search key to search the account management table (see Table 1) and obtain the associated account ID and resource ID (step S23). Due to this configuration, the token issuing unit 32 authenticates the communication terminal that has sent the request to access the resources as the account of the account ID. Moreover, the token issuing unit 32 authorizes the authenticated account to access the resources of the obtained resource ID.

The token issuing unit 32 of the authentication system 30 issues, as access permission indicating permission to access the resources, an access token in which the account ID and the resource ID that are obtained in the step S23 are included and to which digital signature is added (step S24).

The data transmitter and receiver 31 of the management system 50 sends the access token, which is issued in the step S24 in response to the request for the access token, to the communication terminal 10 (step S25). The data transmitter and receiver 11 of the communication terminal 10 receives the access token in the response given from the management system 50.

The data transmitter and receiver 61 of the resource provision system 60 have the basic functions of the TLS communication. The data transmitter and receiver 11 of the communication terminal 10 and the data transmitter and receiver 61 of the resource provision system 60 establishes a connection tls2 that is different from the connection tls1 (step S31).

Once the connection tls2 is established, the data transmitter and receiver 11 of the communication terminal 10 and the data transmitter and receiver 61 of the resource provision system 60 starts the data communication using the data that is encrypted by the common key of the connection tls2. In this communication, the data transmitter and receiver 11 of the communication terminal 10 sends to the resource provision system 60 a request for a resource that includes the access token received in the step S25 and the resource ID of the resource to which access is requested (step S32). The data transmitter and receiver 61 of the resource provision system 60 receives the request for resources in the connection tls2.

The token verification unit 62 of the resource provision system 60 uses the digital signature included in the access token to check whether the access token is issued by the token issuing unit 32 of the authentication system 30 (step S33).

When it is verified that the access token is issued by the token issuing unit 32 of the authentication system 30.

The token verification unit 62 checks whether the resource ID included in the request for resources matches the resource ID included in the access permission of the access token (step S34). When the matching of the resource ID is verified, the token verification unit 62 outputs the access permission to the resource provision unit 63.

Once the access permission is output, the resource provision unit 63 obtains from the memory 6000 the resource 5030 that corresponds to the resource ID included in the request for resources (step S35).

The data transmitter and receiver 61 of the resource provision system 60 sends the resource 5030 obtained by the resource provision unit 63 to the communication terminal 10 that is the request sender, in response to the request for resources (step S36). The data transmitter and receiver 11 of the communication terminal 10 receives the resource 5030 sent from the resource provision system 60. Accordingly, the communication terminal 10 can access the resource 5030.

Note also that the memory 6000 of the resource provision system 60 may store the uniform resource locator (URL) of the resource 5030 in association with the resource ID, instead of the embodiments where the resource 5030 is stored in association with the resource ID. In this configuration, the resource provision unit 63 obtains the URL of the resource 5030 that corresponds to the resource ID included in the request for resources. The data transmitter and receiver 61 of the resource provision system 60 sends the obtained URL to the communication terminal 10 that is the request sender of the resources. Due to this configuration, the communication terminal 10 Can access the resource 5030 based on the obtained URL.

With the authentication and authorization method according to the embodiments described above, the data transmitter and receiver 31 (i.e., an example of an establishment unit) of the authentication system 30 performs authentication with the client certificate sent from the communication terminal 10, and then establishes the connection tls1 (i.e., an example of the first connection) with the communication terminal 10. Note that such establishment is an example of establishing processes. The token issuing unit 32 (i.e., an example of an output unit) of the authentication system 30 outputs an access token that corresponds to the above client certificate as the authorization data indicating the authorization for the communication terminal 10 to access the resources. Note that such an output is an example of outputting processes. The data transmitter and receiver 31 (i.e., an example of a transmitter) of the authentication system 30 transmits the access token to the communication terminal 10. Note that such transmission is an example of transmitting processes. Due to this configuration, the communication terminal 10 sends an access token to the resource provision system 60 through the connection tls2 (i.e., an example of the second connection) that is different from the connection tls1. The data transmitter and receiver 61 (i.e., an example of a receiver) of the resource provision system 60 receives the access token through the connection tls2.

With the authentication and authorization method according to the embodiments described above, the resource provision system 60 that is connected to the connection tls2 can share the authentication information of the communication terminal 10 received by the authentication system 30 that is connected to the connection tls1, which is different from the connection tls2, with the authentication system 30. Due to this configuration, the resource provision system 60 can reduce the load of managing the data that is used for authentication and authorization.

The data transmitter and receiver 31 (i.e., an example of a receiver) of the authentication system 30 receives a request for an access token in the connection tls1. The token issuing unit 32 (i.e., an example of an output unit) of the authentication system 30 outputs an access token including the authorization data that corresponds to the client certificate of the communication terminal that has sent the request for the access token. Due to this configuration, the authentication system 30 can issue an access token that corresponds to the request sender for each of the communication terminals that have sent the requests for the access tokens.

The account management DB 3001 (i.e., an example of a manager) of the authentication system 30 stores the common name (i.e., an example of identification information) included in the client certificate and the resource ID in association with each other. The token issuing unit 32 of the authentication system 30 obtains from the account management DB 3001 the resource ID that is associated with the common name of the client certificate obtained from the communication terminal that has sent the request for the access token outputs an access token that includes the obtained resource ID. Due to this configuration, the authentication system 30 can issue an access token based on the common name included in the client certificate.

Further, the control programs for the communication terminal 10 and the management system 50 may be recorded in a file format installable or executable on a computer-readable recording medium such as the recording medium 106 for distribution. Examples of such recording medium include, but not limited to, compact disc-recordable (CD-R), digital versatile disc (DVD), and Blu-ray disc.

Note also that a recording medium such as a CD-ROM storing the programs according to the example embodiment as described above or the HD 504 storing these programs may be distributed as a program product at home and abroad.

The communication terminal 10 and the management system 50 according to the embodiment as described above may be configured by a single computer or a plurality of computers. According to the embodiments as described above, the elements (functions or units) of the management system 50 are assigned to any one of the authentication system 30 and the resource provision system 60. Alternatively, the management system 50 includes a single authentication system 30 and a plurality of resource provision systems 60. In such a configuration, the authentication system 30 may be managed by the administrator of the entirety of the communication system 1, and each of the resource provision systems 60 may be managed by the provider of each resource.

Moreover, the authentication system 30 and the resource providing system 60 can be configured to share the processing steps disclosed, for example, in FIG. 5, in various combinations other than the above-described embodiment.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions. The processing circuit herein includes, for example, devices such as a processor that is programmed to execute software to implement functions, like a processor with electronic circuits, an application specific integrated circuit (ASIC) that is designed to execute the above functions, and a circuit module known in the art.

Numerous additional modifications and variations are possible in light of the above teachings. It is therefore to be understood that within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

What is claimed is:

1. An authentication system comprising:
an establishment unit to establish a first connection with a communication terminal after performing authentication with client certificate sent from the communication terminal;
an output unit to output authorization data corresponding to the client certificate, the authorization data indicating authorization for the communication terminal to access a resource; and
a transmitter to control the communication terminal to transmit the authorization data to a resource provision system through a second connection different from the first connection.

2. The authentication system according to claim 1, further comprising a receiver to receive a request for the authorization data through the first connection,
wherein the output unit outputs the authorization data corresponding to the client certificate of the communication terminal that has sent the request for the authorization data.

3. The authentication system according to claim 2, further comprising a manager to store identification information included in the client certificate and identification information of the resource in association with each other,
wherein the output unit obtains from the manager the identification information of the resource stored in association with the identification information included in the client certificate, and outputs the authorization data including the obtained identification information of the resource.

4. A communication system comprising:
a resource provision system to check authorization data and provide a communication terminal with a resource, the authorization data indicating authorization for the communication terminal to access the resource; and
an authentication system comprising:
an establishment unit to establish a first connection with the communication terminal after performing authentication with client certificate sent from the communication terminal;
an output unit to output the authorization data corresponding to the client certificate; and
a transmitter to control the communication terminal to transmit the authorization data to the resource provision system through a second connection different from the first connection.

5. The communication system according to claim 4, wherein the resource provision system receives the authorization data through the second connection.

6. The communication system according to claim 4, further comprising a communication terminal.

7. The communication system according to claim 6, wherein the communication terminal receives the authorization data through the first connection established with the authentication system, and sends the authorization data through the second connection established with the resource provision system.

8. A method of performing authentication and authorization, the method comprising:
establishing a first connection with a communication terminal after performing authentication with client certificate sent from the communication terminal;
outputting authorization data corresponding to the client certificate, the authorization data indicating authorization for the communication terminal to access a resource; and
controlling the communication terminal to transmit the authorization data to a resource provision system through a second connection different from the first connection.

9. The method according to claim 8, further comprising:
checking the authorization data; and
providing the communication terminal with the resource.
